(19) United States
(12) Patent Application Publication
(10) Pub. No.: US 2015/0242133 A1
(43) Pub. Date: Aug. 27, 2015

(54) STORAGE WORKLOAD HINTING

(71) Applicant: LSI Corporation, San Jose, CA (US)

(72) Inventors: Hubbert Smith, Sandy, UT (US); Kimberly K. Leyenaar, Orlando, FL (US)

(73) Assignee: LSI CORPORATION, San Jose, CA (US)

(21) Appl. No.: 14/186,241

(22) Filed: Feb. 21, 2014

(51) Int. Cl. G06F 3/06

(52) U.S. Cl. CPC G06F 3/0613; G06F 3/0689; G06F 3/0665

(57) ABSTRACT

Methods and structure for reconfiguring storage systems are provided. One exemplary embodiment is a storage controller. The storage controller includes a memory that stores multiple profiles that are each designated for a different type of Input/Output processing workload from a host, and each include settings for managing communications with coupled storage devices. Each type of workload is characterized by a pattern of Input/Output requests from the host. The storage controller also includes a control unit able to process host Input/Output requests at the storage controller in accordance with a first profile, identify a change in type of workload from the host, and load a second profile designated for the changed type of workload in place of the first profile. The control unit is also able to process host Input/Output requests at the storage controller in accordance with the second profile.

### FIELD OF THE INVENTION

The invention relates generally to data storage technology, and more specifically to data storage systems.

### BACKGROUND

“Big Data” is a term used to describe storage systems that provide massive amounts of storage (e.g., exceeding multiple petabytes) to users for any of a variety of purposes. Big Data systems may store many different types of information for users. For example, a Big Data storage system may store video streaming data for a surveillance system of one user (e.g., a government entity), while also storing relational database information for a website of another user (e.g., a corporation). By enabling the offloading of storage maintenance and retrieval processes, Big Data storage systems reduce the amount of capital expense borne by users.

### SUMMARY

One exemplary embodiment is a storage controller. The storage controller includes a memory that stores multiple profiles that are each designated for a different type of Input/Output processing workload from a host, and each include settings for managing communications with coupled storage devices. Each type of workload is characterized by a pattern of Input/Output requests from the host. The storage controller also includes a control unit able to process host Input/Output requests at the storage controller in accordance with a first profile, identify a change in type of workload from the host, and load a second profile designated for the changed type of workload in place of the first profile. The control unit is also able to process host Input/Output requests at the storage controller in accordance with the second profile.

Other exemplary embodiments (e.g., methods and computer readable media relating to the foregoing embodiments) are also described below.

### BRIEF DESCRIPTION OF THE FIGURES

Some embodiments of the present invention are now described, by way of example only, and with reference to the accompanying figures. The same reference number represents the same element or the same type of element on all figures.

FIG. 1 is a block diagram of an exemplary storage system.

FIG. 2 is a flowchart describing an exemplary method for operating a storage system.

FIG. 3 is a message diagram illustrating exemplary switching between workload profiles for a storage controller.

FIG. 4 is a table illustrating an exemplary variety of workload profiles.

FIG. 5 is a block diagram illustrating an exemplary command to change a workload profile at a storage controller.

FIG. 6 illustrates an exemplary processing system operable to execute programmed instructions embodied on a computer readable medium.

### DETAILED DESCRIPTION OF THE FIGURES

The figures and the following description illustrate specific exemplary embodiments of the invention. It will thus be appreciated that those skilled in the art will be able to devise various arrangements that, although not explicitly described or shown herein, embody the principles of the invention and are included within the scope of the invention. Furthermore, any examples described herein are intended to aid in understanding the principles of the invention, and are to be construed as being without limitation to such specifically recited examples and conditions. As a result, the invention is not limited to the specific embodiments or examples described below, but by the claims and their equivalents.

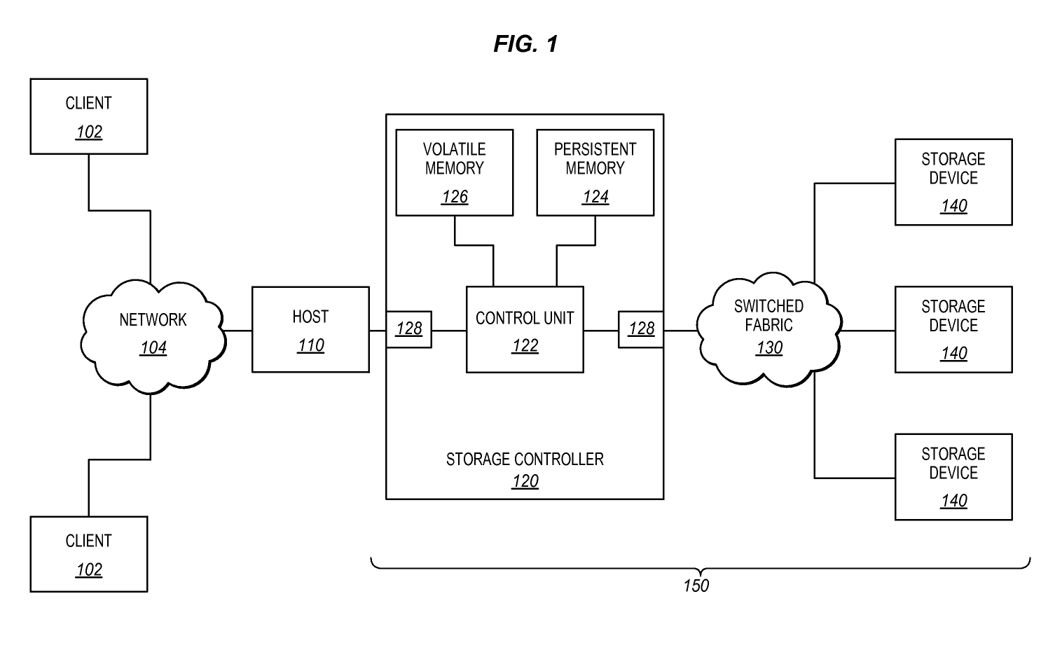

FIG. 1 is a block diagram of an exemplary storage system 150. Storage system 150 includes storage controller 120, which maintains multiple different profiles that are each designed to adapt storage system 150 to a different type of Input/Output (I/O) processing workload from host 110. Each profile includes settings for managing communications with storage devices 140. For example, one profile may be adapted for latency sensitive I/O workloads generated by search tools, while another profile may be adapted for bandwidth-heavy workloads generated by video surveillance systems. By swapping between profiles, storage controller 120 adapts to the varying characteristics of different host I/O workloads.

In the embodiment shown in FIG. 1, one or more clients 102 communicate with a host device 110 via a network 104, such as the Internet. Host device 110 (e.g., a server) in turn communicates with storage controller 120 in order to service Input and/or Output operations (I/O) directed to storage system 150. Although host 110 is shown as directly coupled with storage system 150 in FIG. 1, in many embodiments storage system 150 operates as a Storage As A Service (SAAS) provider that is remotely accessible to host 110 (e.g., via a network or a switched fabric).

Storage controller 120 manages the operations of coupled storage devices 140 via switched fabric 130 in order to write and/or retrieve data as requested by host 110 (or multiple hosts). Switched fabric 130 comprises any suitable combination of communication channels operable to forward/route communications for storage system 150, for example, according to protocols for one or more of Small Computer System Interface (SCSI), Serial Attached SCSI (SAS), FibreChannel, Ethernet, Internet SCSI (ISCSI), etc. In one embodiment, switched fabric 130 comprises a combination of SAS expanders that each link to one or more storage devices that operate as SAS and/or Serial Advanced Technology Attachment (SATA) targets. In an alternate embodiment, storage controllers 120 and storage devices 140 are directly connected without employing a fabric.

Storage devices 140 implement the persistent storage capacity of storage system 150, and are capable of writing and/or reading data in a computer readable format. For example, in various embodiments storage devices 140 comprise magnetic hard disks, solid state drives, optical media, etc. compliant with protocols for SAS, Serial Advanced Technology Attachment (SATA), Fibre Channel, etc.

As shown in FIG. 1, in this embodiment storage controller 120 comprises control unit 122, persistent memory 124, volatile memory 126, and multiple physical links (PHYs) 128. Control unit 122 manages the activities performed by storage controller 120, while persistent memory 124 stores multiple profiles that each include settings for storage system 150. The settings may, for example, control Input/Output traffic handling (e.g., by adjusting cache sizes and buffering techniques), adjust how data is stored within storage devices 150 (e.g., by adjusting a RAID parameter), etc. Control unit 122 can be implemented as custom circuitry, a processor executing programmed instructions stored in program memory, or some combination thereof.

In one embodiment, control unit 122 loads these profiles from persistent memory 124 into volatile memory 126 (e.g., a Random Access Memory (RAM)), and utilizes loaded profiles to alter how storage system 150 functions. In this manner, storage controller 120 may adapt storage system 150 to different types of incoming I/O workloads from host 110. Adjusting storage system settings regularly based on a profile helps storage system 150 to adapt to changing conditions. For example, in a Storage As A Service (SAAS) environment, the I/O workload from host 110 may vary from ingest, sequential workload requests (e.g., for one client) to primarily transactional requests for a website (e.g., for another client). For each of these workloads a different combination of I/O caching and queuing settings may be desired in order for storage system 150 to function efficiently. For example, it may be beneficial to coalesce I/O requests together in bandwidth-intensive ingest sequential workloads, because this enhances the overall bandwidth of the system. At the same time, it may be undesirable to coalesce I/O requests when servicing transactional requests for a website, as this increases latency while providing little or no benefit to users.

The particular arrangement, number, and configuration of components described herein is exemplary and non-limiting.

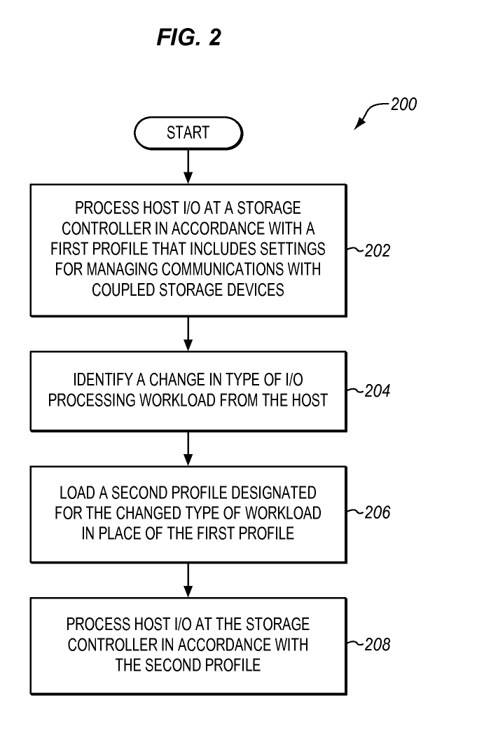

FIG. 2 is a flowchart describing an exemplary method 200 for operating a storage system. Assume, for this embodiment, that storage controller 120 has initialized storage system 150 with a variety of system settings indicated in a first profile. The first profile is designated for processing a first type of I/O workload from host 110, and includes settings for managing communications with storage devices 140.

As used herein, an “I/O processing workload” is a pattern of reads and/or writes from a host that are expected to generally share certain characteristics/properties, such as a request size, whether the requests are primarily reads or writes, whether the requests are sequential, etc. In one example, one I/O workload is associated with large read operations directed to sequential locations in memory, while another workload is associated with small low-latency writes to unpredictable/random memory locations. In a further example, workloads are classified based on the expected sensitivity to bandwidth and/or latency of their underlying I/O requests.

The settings found in a profile are used to control the behavior of storage controller 120, switched fabric 130, and/or storage devices 140. In one embodiment the profiles include storage system settings such as a Redundant Array of Independent Disks (RAID) stripe size, a maximum number of commands per disk over a unit time, a maximum number of commands per logical volume over a unit time, a maximum number of commands per Logical Unit Number (LUN), a write cache setting, a read cache setting, a cache flush parameter of a cache operating in write back mode, whether or not data placement is performed via a “through” cache or via Direct Memory Access (DMA), a Replication, Recovery, or Redundant Array of Independent Disks (RAID) type, a data replication parameter, a data recovery parameter, whether coalescing of Input/Output commands is enabled, whether re-ordering of Input/Output commands is enabled, whether or not direct path (e.g., FASTPATH technology features available through the LSI Corporation) Input/Output is enabled, whether or not Write Ahead Logging (WAL) features are enabled, whether front of queue disk features are enabled, etc. Such settings are more generally known as storage subsystem configuration parameters.

In step 202, control unit 122 operates storage controller 120 in accordance with the first profile. Thus, in step 202, storage system 150 has been configured to implement settings from the first profile when processing I/O requests from host 110. In step 204, control unit 122 detects a change in type of I/O processing workload from host 110. The change in I/O processing workload may be detected in any suitable manner.

In one example, the change in I/O processing workload is explicitly indicated by a command/parameter sent from host 110 to storage controller 120 (e.g., a “hint” field included in an Open Address From sent from host 110 to storage controller 120 in accordance with an Application Programming Interface (API) supported by storage controller 120). This input helps storage controller 120 to change profiles pre-emptively in order to deal with a new type of I/O workload. This input may further explicitly indicate one or more storage system settings to apply in addition to the settings that are listed in the profile itself

In a further example, the type of I/O workload from host 110 predictably varies with the time of day. In such an embodiment, control unit 122 is configured to switch profiles depending upon the time of day in order to account for the change in type of workload.

In yet another example, the change in type of workload is detected by control unit 122 as control unit 122 “snoops”/acquires I/O passing through/processed by storage controller 120 over a period of time (e.g., an hour, several minutes, a few seconds, etc.). In one embodiment control unit 122 determines the type of workload by analyzing a series of received I/O commands, and determining whether the I/O requests relate to a contiguous series of logical addresses, what size the I/O requests are, whether or not the I/O requests request a certain speed of response (e.g., latency), a bandwidth used by the I/O requests, a read/write ratio, a ratio of data moved by writes versus reads, an I/O queue depth, and/or whether writes are performed sequentially or not. Based on this and similar information, control unit 122 classifies the I/O workload into a specific category/type.

Once the change in type of I/O workload from host 110 has been identified, storage controller 120 loads a second profile designated for the new type of I/O workload (e.g., from persistent memory 124 into volatile memory 126), and operates storage controller 120 in accordance with the second profile in step 206. In one embodiment, step 206 includes sending out commands to change various settings on storage devices 140, switched fabric 130, and/or within storage controller 120 itself. Depending on the settings changed, this reconfiguration of storage system 150 may interfere with I/O processing and management at storage controller 120. If necessary, storage controller 120 takes storage system 150 offline during this time, or degrades performance at storage system 150 as the settings are changed.

Once the settings have been applied, storage system 150 has been configured in accordance with the second profile. Since the second profile includes settings that are specifically adapted to the new workload, storage system 150 is capable of processing these types of I/O requests in aggregate more efficiently than before. This in turn enhances the overall speed of storage system 150, which ensures that storage system 150 provides a substantial benefit to its users, even when those users utilize storage system 150 for very different types of tasks over time.

Though the steps of method 200 are described with reference to storage system 150 of FIG. 1, method 200 can be performed in other storage systems. The steps of the flowcharts described herein are not all inclusive and can include other steps not shown. The steps described herein can also be performed in an alternative order.

### EXAMPLES

In the following examples, additional processes, systems, and methods are described in the context of a storage system that changes between profiles in order to adapt to changes in I/O processing workloads from a host. Assume, for this example, that a host operates different applications that are each associated with a different type of I/O processing workload. The host changes the application that it uses unexpectedly, and a storage controller dynamically swaps between profiles based upon detected changes in I/O requests from the host.

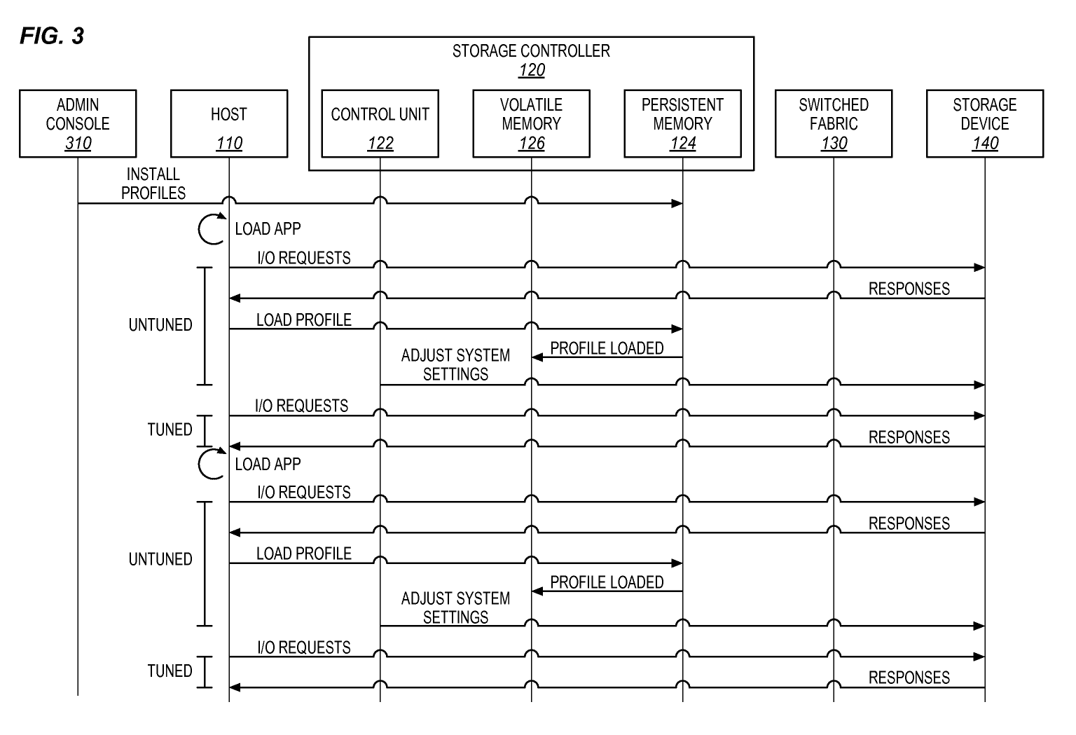

FIG. 3 is a message diagram illustrating exemplary switching between workload profiles for storage controller 120. In this example, at start of day for the storage system (i.e., when the storage system is initially configured), an administrator installs multiple profiles into persistent memory 124 of storage controller 120 via an administrative console 310. The administrator further selects an initial profile to be used by the storage system, and the storage system initializes based on the settings in the profile.

The storage system then begins operating, and in this example host 110 loads a data ingest application (e.g. for video streaming) into its RAM in order to service the needs of a client 102. The application stores incoming ingested data at the storage system by sending I/O requests to storage device 140 via storage controller 120. The storage system is not currently loaded with a profile that is intended to service this type of high-bandwidth, latency insensitive workload, and therefore the storage system operates in a sub-optimal “untuned” manner wherein the incoming I/O requests are serviced, but are not serviced as quickly as would be possible if the storage system was configured differently.

Control unit 122 continuously monitors I/O being processed by storage controller 120 over the last minute of time, and tracks various parameters, including the number of read requests, number of write requests, size of read requests, size of write requests, and addresses indicated by each I/O request. Control unit 122 then categorizes the I/O processing workload into a category based on these characteristics. Control unit 122 need not find that each and every I/O request have the exact same characteristics when classifying the type of workload. Instead, control unit 122 detects general trends which indicate that many of the incoming I/O requests share certain characteristics.

In this example, the first type of I/O workload (i.e., the application messaging and responses) is associated with a “streaming ingest” type of workload characterized by large write requests directed to sequential addresses in memory. Therefore, control unit 122 loads a new profile for “streaming ingest” workloads into memory. In this example, the new profile includes settings that coalesce and re-order I/O requests. Depending on the storage type, the settings may also allow for incoming data to be directly transferred to permanent storage. The new profile also includes a setting that allocates a much larger write cache size than the previous profile. These settings enhance the ability of storage system 150 to increase its overall bandwidth.

Once the profile has been loaded, its settings are applied to the storage system (e.g., to re-allocate portions of RAM within storage controller 120, which increases the write cache size. A larger write cache ensures that more incoming write commands can be processed at a time by storage controller 120 than before. A larger write cache also helps to reduce latency for write commands at storage controller 120. Therefore, at this point, the storage system has been “tuned” for the incoming workload and may process received I/O for the workload more effectively, owing to the settings that are adapted to this specific type of I/O from host 110.

At some point in time, host 110 closes/deprecates the current application and loads a new application. This may occur for any number of reasons. For example, traffic may be low for the old application and its I/O load may drop, a user may request that the new application be loaded, a new user may start using applications on host 110, etc.

The new application focuses on email services, which utilize a different type of I/O processing workload characterized by small request sizes, high temporal locality, and low queue depth. Control unit 122 then analyzes the new workload and loads a new profile for storage system 150 in order to tune storage system 150 for the new type of I/O workload.

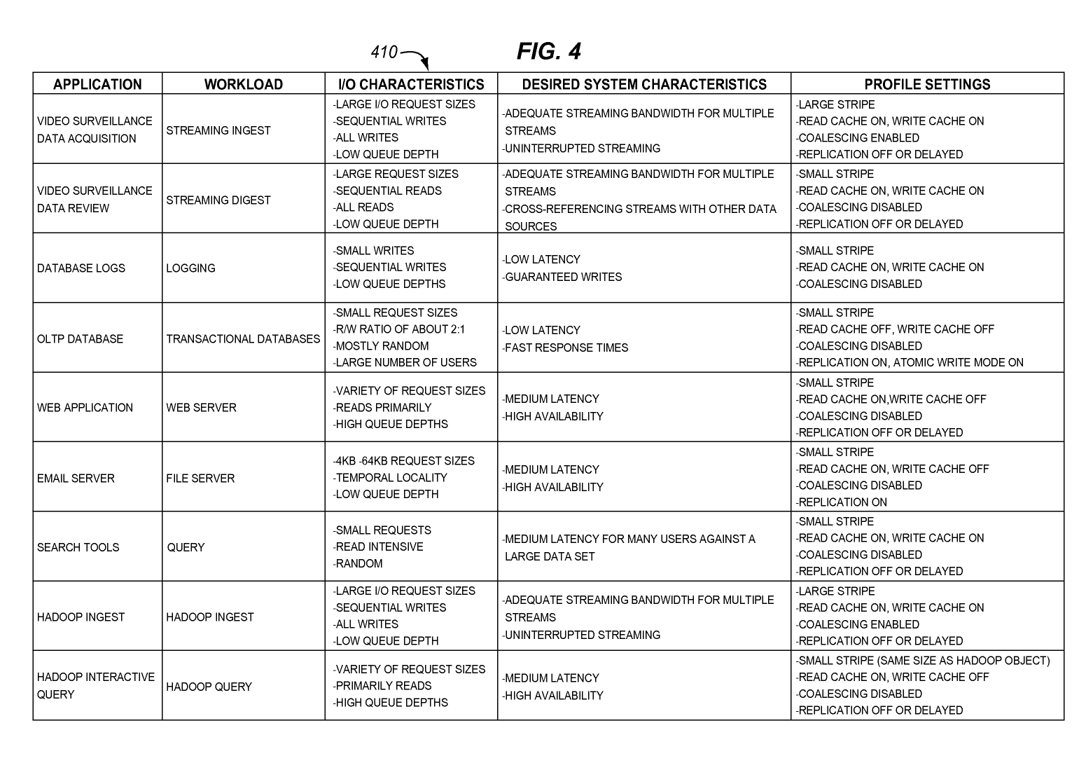

FIG. 4 is a table 410 illustrating an exemplary variety of workload profiles. As shown in FIG. 4, each type of workload is characterized by any suitable combination of I/O characteristics, each type of workload is associated with certain desired storage system characteristics (e.g., low latency, high bandwidth, guaranteed writes, etc.). FIG. 4 additionally shows profile settings that enable enhanced processing of their associated workloads.

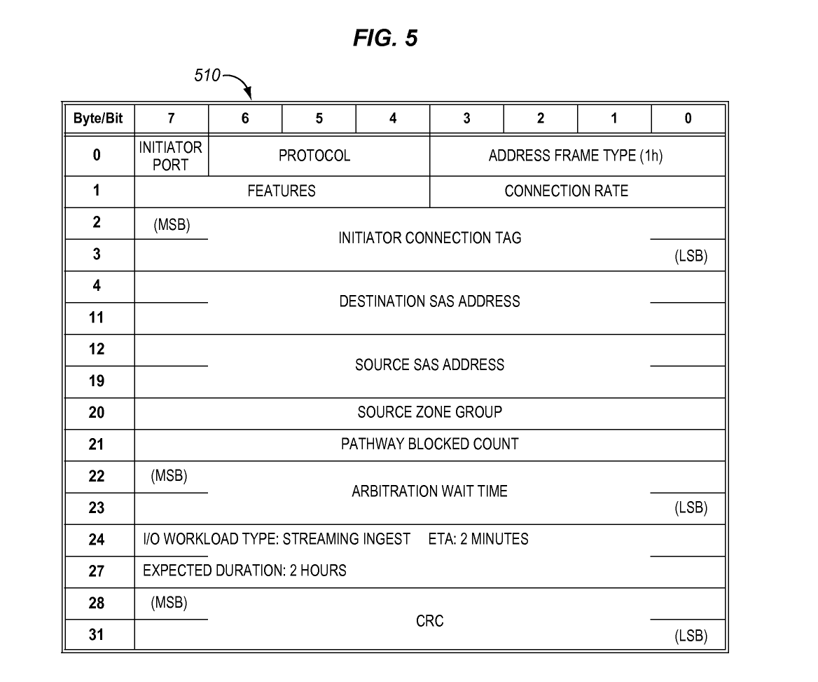

FIG. 5 is a block diagram illustrating an exemplary command 510 to change a workload profile at a storage controller. In this example, command 510 is a SAS OPEN Address Frame generated by host 110 and provided to storage controller 120 in order to “hint” that the type of I/O workload at storage controller 120 is about to change. The hint, located within bytes 24-27 of the OPEN address frame, explicitly indicates an upcoming type of I/O processing workload (e.g., by name or number) from the host. In this example, the hint also includes an Estimated Time of Arrival (ETA) for the workload in order to inform storage controller 120 of the amount of time it has to prepare for the new workload. Furthermore, in this example the hint additionally includes an expected duration of the new workload. In further embodiments, hints provide information about Service Level Agreement (SLA) requirements, storage tiering requirements, durability or transiency of data (e.g., whether there are temporary files that will be deleted after a job completes), etc.

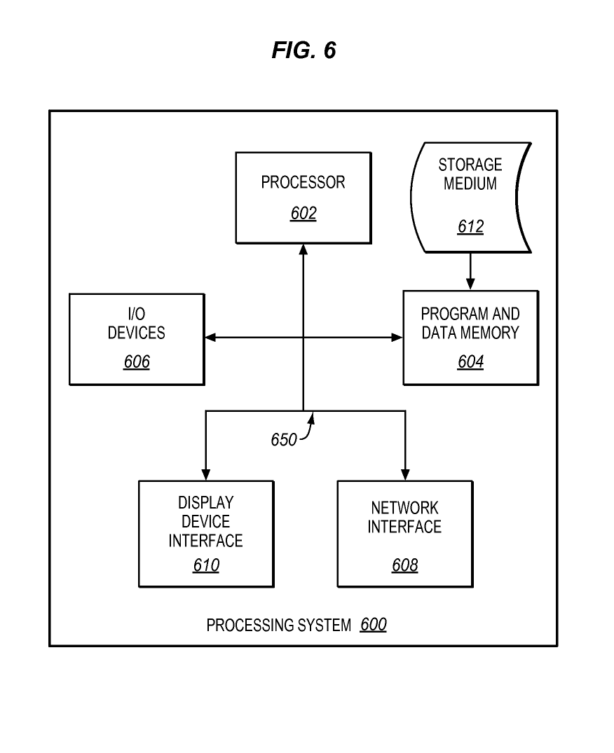

Embodiments disclosed herein can take the form of software, hardware, firmware, or various combinations thereof on both hosts and storage subsystems. In one particular embodiment, software is used to direct a processing system of storage controller 120 to perform the various operations disclosed herein. FIG. 6 illustrates an exemplary processing system 600 operable to execute a computer readable medium embodying programmed instructions. Processing system 600 is operable to perform the above operations by executing programmed instructions tangibly embodied on computer readable storage medium 612. In this regard, embodiments of the invention can take the form of a computer program accessible via computer readable medium 612 providing program code for use by a computer (e.g., processing system 600) or any other instruction execution system. For the purposes of this description, computer readable storage medium 612 can be anything that can contain or store the program for use by the computer (e.g., processing system 600).

Computer readable storage medium 612 can be an electronic, magnetic, optical, electromagnetic, infrared, or semiconductor device. Examples of computer readable storage medium 612 include a solid state memory, a magnetic tape, a removable computer diskette, a random access memory (RAM), a read-only memory (ROM), a rigid magnetic disk, and an optical disk. Current examples of optical disks include compact disk—read only memory (CD-ROM), compact disk—read/write (CD-R/W), and DVD.

Processing system 600, being suitable for storing and/or executing the program code, includes at least one processor 602 coupled to program and data memory 604 through a system bus 650. Program and data memory 604 can include local memory employed during actual execution of the program code, bulk storage, and cache memories that provide temporary storage of at least some program code and/or data in order to reduce the number of times the code and/or data are retrieved from bulk storage during execution.

Input/output or I/O devices 606 (including but not limited to keyboards, displays, pointing devices, etc.) can be coupled either directly or through intervening I/O controllers. Network adapter interfaces 608 can also be integrated with the system to enable processing system 600 to become coupled to other data processing systems or storage devices through intervening private or public networks. Modems, cable modems, IBM Channel attachments, SCSI, Fibre Channel, and Ethernet cards are just a few of the currently available types of network or host interface adapters. Display device interface 610 can be integrated with the system to interface to one or more display devices, such as printing systems and screens for presentation of data generated by processor 602.

What is claimed is:

1. A storage controller comprising:
a memory that stores multiple profiles, each profile designated for a different type of Input/Output processing workload from a host, wherein each profile includes settings for managing communications with coupled storage devices, and each type of workload is characterized by a pattern of Input/Output requests from the host; and
a control unit configured to process host Input/Output requests at the storage controller in accordance with a first profile, identify a change in type of workload from the host, load a second profile designated for the changed type of workload in place of the first profile, and process host Input/Output requests at the storage controller in accordance with the second profile.

2. The storage controller of claim 1, wherein:
each type of workload is associated with a different combination of latency and bandwidth.

3. The storage controller of claim 1, wherein:
the control unit is further configured to identify the change in type of workload based on a time of day.

4. The storage controller of claim 1, wherein:
each type of workload is characterized by at least one property selected from the group consisting of: a read/write ratio, a ratio of data moved by writes versus reads, an Input/Output queue depth, an Input/Output request size, and whether Input/Output requests are performed sequentially or not.

5. The storage controller of claim 1, wherein:
the control unit is further configured to identify the change in type of workload by receiving a command from the host that indicates the changed type of workload.

6. The storage controller of claim 1, wherein:
the control unit is further configured to identify the change in type of workload by analyzing Input/Output requests that have been processed by the storage controller over a period of time.

7. The storage controller of claim 1, wherein the settings are selected from the group consisting of:
a Redundant Array of Independent Disks (RAID) stripe size, a maximum number of commands per disk over a unit time, a maximum number of commands per logical volume over a unit time, a write cache setting, a read cache setting, a cache flush parameter of a write back cache, a Redundant Array of Independent Disks (RAID) level, a data replication parameter, a data recovery parameter, whether or not coalescing of Input/Output commands is enabled, whether or not re-ordering of Input/Output commands is enabled, whether or not FastPath Input/Output is enabled, whether or not Write Ahead Logging (WAL) is enabled, and whether front of queue disk features are enabled.

8. A storage controller comprising:
means for storing multiple profiles, each profile designated for a different type of Input/Output processing workload from a host, wherein each profile includes settings for managing communications with coupled storage devices, and each type of workload is characterized by a pattern of Input/Output requests from the host; and
means for processing host Input/Output requests at the storage controller in accordance with a first profile, identifying a change in type of workload from the host, loading a second profile designated for the changed type of workload in place of the first profile, and processing host Input/Output requests at the storage controller in accordance with the second profile.

9. The storage controller of claim 8, wherein:
each type of workload is associated with a different combination of latency and bandwidth.

10. The storage controller of claim 8, wherein:
the storage controller is configured to identify the change in type of workload based on a time of day.

11. The storage controller of claim 8, wherein:
each type of workload is characterized by at least one property selected from the group consisting of: a read/write ratio, a ratio of data moved by writes versus reads, an Input/Output queue depth, an Input/Output command size, and whether writes are performed sequentially or not.

12. The storage controller of claim 8, wherein:
the storage controller is configured to identify the change in type of workload by receiving a command from the host that indicates the changed type of workload.

13. The storage controller of claim 8, wherein:
the storage controller is configured to identify the change in type of workload by analyzing Input/Output operations that have been processed by the storage controller over a period of time.

14. The storage controller of claim 8, wherein the settings are selected from the group consisting of:
a Redundant Array of Independent Disks (RAID) stripe size, a maximum number of commands per disk over a unit time, a maximum number of commands per logical volume over a unit time, a write cache setting, a read cache setting, a cache flush parameter of a write back cache, a Redundant Array of Independent Disks (RAID) level, a data replication parameter, a data recovery parameter, whether or not coalescing of Input/Output commands is enabled, whether or not re-ordering of Input/Output commands is enabled, whether or not FastPath Input/Output is enabled, whether or not Write Ahead Logging (WAL) is enabled, and whether front of queue disk features are enabled.

15. A method comprising:
processing host Input/Output requests at a storage controller in accordance with a first profile that includes settings for managing communications with coupled storage devices;
identifying a change in type of Input/Output processing workload from the host, wherein types of workload are characterized by a pattern of Input/Output requests from the host;
loading a second profile designated for the changed type of workload in place of the first profile, wherein the second profile includes settings for managing communications with the coupled storage devices; and
processing host Input/Output requests at the storage controller in accordance with the second profile.

16. The method of claim 15, wherein:
each type of workload is associated with a different combination of latency and bandwidth.

17. The method of claim 15, further comprising:
identifying the change in type of workload based on a time of day.

18. The method of claim 15, wherein:
each type of workload is characterized by at least one property selected from the group consisting of: a read/write ratio, a ratio of data moved by writes versus reads, an Input/Output queue depth, an Input/Output command size, and whether writes are performed sequentially or not.

19. The method of claim 15, further comprising:
identifying the change in type of workload by receiving a command from the host that indicates the changed type of workload.

20. The method of claim 15, further comprising:
identifying the change in type of workload by analyzing Input/Output operations that have been processed by the storage controller over a period of time.
